(19) United States
(12) Patent Application Publication
(10) Pub. No.: US 2020/0311657 A1
(43) Pub. Date: Oct. 1, 2020

(54) SUPPLY CHAIN OPTIMIZATION AND INVENTORY MANAGEMENT SYSTEM

(71) Applicant: Goodpace Company, LLC, Salt Lake City, UT (US)

(72) Inventors: Aaron L. Pace, Salt Lake City, UT (US); Joseph E. Goodmann, III, Salt Lake City, UT (US)

(21) Appl. No.: 16/501,125

(22) Filed: Mar. 27, 2019

(51) Int. Cl. G06Q 10/08; G06Q 10/06; G06Q 30/06; H04W 4/12

(52) U.S. Cl. CPC G06Q 10/087; G06Q 10/0835; H04W 4/12; G06Q 30/0631; G06Q 30/0635; G06Q 10/06315

(57) ABSTRACT

Optimizing supply chain and inventory management. Accessing a distributor's computing system to obtain distributor's data including information related a plurality of the distributor's inventory items and a corresponding supplier for each of the plurality of inventory items. Also accessing a data system including information related to a plurality of suppliers. Based on the distributor' s data, retrieving each of the corresponding suppliers' information from the data system. Based on the accessed distributor's data and the corresponding suppliers' information, predicting a future need of at least one of the plurality of inventory items. Based on the predicted future need, generating a recommendation of a purchase order.

### BACKGROUND OF THE INVENTION

In commerce, supply-chain management is the management of the flow of goods and services. Supply-chain management involves the movement and storage of raw materials, of work-in-process inventory, and of finished goods from point of origin to point of consumption. Interconnected or interlinked networks, channels and node businesses combine in the provision of products and services required by end customers in a supply chain. Higher level suppliers (e.g., manufactures) will supply goods to its distributors. The distributors will then distribute the goods to a lower level distributor or sell the goods to consumers.

The common practice in the industry is that a distributor will purchase many inventory items from multiple suppliers. The number of the inventory items are often very large, so that one person cannot manage. Thus, multiple buyers are often hired to manage a portion of the inventory items. The buyers need to review the number of inventory unit in stock, and based on the past sales to determine how many units should be ordered and around what time. On the other side, the distributors also must hire people to manage purchase orders. To reduce overhead, many distributors have a minimum order requirement. This could create a tension between the distributors and the suppliers. If the product is not selling as quickly on the distributor's side, and the supplier has a large minimum order requirement, the distributor may have to have a large amount of inventory in stock for a long period of time. This will increase the distributor's storage and maintenance expense. Furthermore, when an inventory item is not ordered regularly, the buyer may overlook it until it is on backorder.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiment disclosed herein are related to computing systems, and methods implemented in a computing system for optimizing supply chain and inventory management. The methods include accessing a distributor's data including information related to a plurality of inventory items, and each of the corresponding suppliers, and accessing supplier's data including information related to a plurality of suppliers. Based on the distributor's inventory data and the corresponding suppliers, the relevant suppliers' information is retrieved. Thereafter, based on the distributor's data and the relevant supplier's information, a future need of at least one of the inventory items of the distributor is generated. Based on the predicted future need, a recommendation of a purchase order may then be generated.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates an example computing system in which the principles described herein may be employed;

FIG. 2 illustrates an example environment in which an optimized supply chain and inventory management system may be implemented;

FIG. 3 illustrates an example embodiment of the optimized supply chain and inventory management system;

FIG. 4 illustrates a flow chart of an example method for optimizing supply chain and inventory management;

FIG. 5 illustrates a flow chart of an example method for predicting a future need of at least one of the items of the distributor;

FIG. 6 illustrates a flow chart of an example method for generating a recommendation of a purchase order;

FIG. 7 illustrates a flow chart of an example method for generating a customized recommendation of a purchase order based on a particular distributor or buyer's past records;

FIG. 8 illustrates an example user inter face of a main menu;

FIG. 9 illustrate an example visualization generated by the supply barometer module;

FIGS. 10-13 illustrate different example visualizations generated by the inventory replenish calculator module;

FIGS. 14-20 illustrate different example visualizations generated by the supplier performance report module;

FIG. 21 illustrates an example visualization generated by the null matrix; and

FIG. 22 illustrates an example visualization generated by the Item Health Tool. Partial information on the visualizations are redacted.

### DETAILED DESCRIPTION

Embodiment disclosed herein are related to computing systems, and methods implemented in a computing system for optimizing supply chain and inventory management. The methods include accessing a distributor's data including information related to a plurality of inventory items, and each of the corresponding suppliers, and accessing supplier's data including information related to a plurality of suppliers. Based on the distributor's inventory data and the corresponding suppliers, the relevant suppliers' information is retrieved. Thereafter, based on the distributor's data and the relevant supplier's information, a future need of at least one of the inventory items of the distributor is generated. Based on the predicted future need, a recommendation for a purchase order is then generated.

The principles described herein provide a technical advance to help buyers at distributors to generate purpose orders more efficiently, such that each buyer can manage a larger number of inventory items, and fewer buyers are required for a distributor. The principles described herein also allows the distributor to reduce the volume of inventory stored on site, at the same time reduces customer back orders.

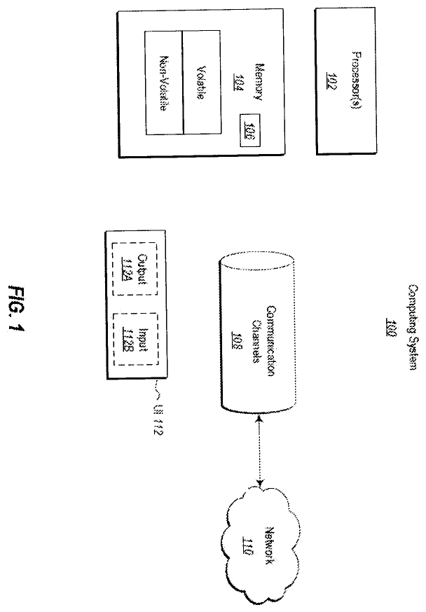

Because the principles described herein may be performed in the context of a computing system, some introductory discussion of a computing system will be described with respect to FIG. 1. Then, this description will return to the principles of the optimized supply chain and inventory management system with respect to the remaining figures.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The processing unit 102 may include a general purpose processor and may also include a field programmable gate array (FPGA), an application specific integrated circuit (ASIC), or any other specialized circuit. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard coded or hard wired logic gates. The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing system which may correspond to the computing system 100 previously described. The computing systems of the remaining figures include various components or functional blocks that may implement the various embodiments disclosed herein as will be explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems of the remaining figures may include more or less than the components illustrated in the figures and some of the components may be combined as circumstances warrant. Although not necessarily illustrated, the various components of the computing systems may access and/or utilize a processor and memory, such as processor 102 and memory 104, as needed to perform their various functions.

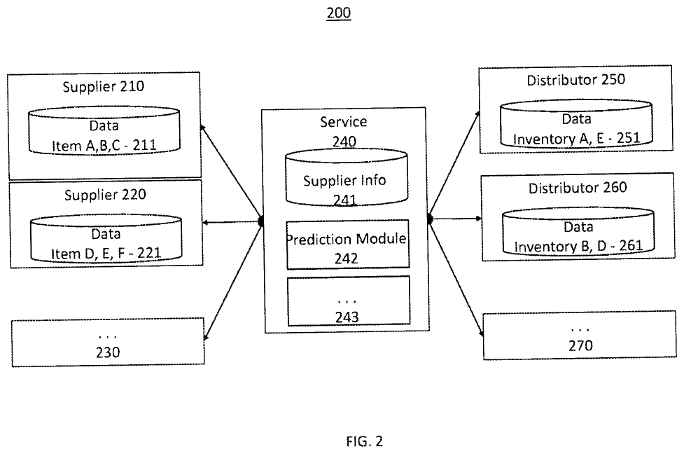

Having described an example computing system with reference to FIG. 1, an optimized supply chain and inventory management system will now be explained. Turning now to FIG. 2, FIG. 2 illustrates an example environment 200 in which an optimized supply chain and inventory management system may be implemented. In a supply chain, there are many different suppliers 210, 220 and 230. The ellipsis 230 represents that there may be any number of the supplier in the supply chain.

Each of the suppliers 210, 220 and 230 supplies a sets of inventory items. Each of these inventory items supplied by the corresponding supplier often has a unit price and a minimum order requirement. Each of the suppliers 210, 220, and 230 often stores such information in its computing system (e.g., in databases). For example, the supplier 210 may supply items A, B, and C, and each item A, B, or C's unit price, minimum order and/or other related information may be stored in the data system 211. The supplier 220 may supply items D, E, and F, and each item D, E, or F's unit price, minimum order and/or other related information may be stored in the data system 221.

Since the principles described herein is implemented in a computing system, throughout this application the term “supplier” and “supplier's computing system” may be interchangeable. Thus, in FIG. 2, each of the suppliers 210, 220 and 230 may also represent the supplier's computing system that includes user interfaces that allow employees to interact with the data stored in the computing system.

In the supply chain environment 200, there are also many different distributors 250, 260 and 270. The ellipsis 270 represents that there may be any number of distributors that make orders from the suppliers 210, 220 and 230. Each of the distributors 250, 260 and 270 often stores its inventory and purchase order related information in its computing system. For example, the distributor 250 may distribute inventory items A and E, and each of items A and E's information including, but not limited to, number of unit in stock and information related to past purchase orders, is stored in the distributor 250's data system 251. The distributor 260 may distribute inventory items B and D, and each items B and D's information may be store in the distributor 260's data system 261. Similarly, each of the distributors 250, 260 and 270 may also represent the corresponding distributor's computing system that includes user interfaces allowing customer services, buyers, management and other personnel to interact with the data stored in the computing system.

In a supply chain environment, a distributor often distributes many different inventory items. These items are divided into groups and assigned to individual buyers to manage. The existing distributor's inventory management systems often do not have supplier's information readily available. Each buyer often has to manually review the supplier's information, and the inventory information to determine whether a purchase order should be made, and how many units should be ordered.

The principles described herein illustrates an improved supply chain and inventory management system. As illustrated in FIG. 2, in the supply chain environment 200, a service 240 is provided to help the distributors 250, 260 and 270 to manage their inventories. The service 240 may be a computing system that provides a cloud service and/or a web service. The service 240 has access to a data system 241 that includes multiple suppliers' information. The service 240 also has access to each distributor 250 and/or 260's data systems 251 and/or 261. Based on the distributor's data, the service 240 determines the suppliers from which the distributor has made orders in the past, and the current inventories in stock which were ordered from these suppliers. The service 240 then retrieves each of the relevant suppliers' information from the data system 241.

The service 240 further includes a prediction module 242. Based on the distributor's data and the retrieved relevant suppliers' information, the prediction module 242 is configured to predict a future need of at least one of the inventory items of the distributor. Based on the predicted future need, the service system 240 may then generate a recommendation of a purchase order.

Each distributor may have many distribution locations, and each location may have same or different inventory items. The service system 240 may access each location's information for each distributor, and based on each location's information to generate an estimate and recommended purchase order for the distributor as a whole, or generate an estimate and recommended purchase order for each of the locations.

In some embodiments, the service system 240 periodically query each distributor's data systems 251 and 261 to receive the most updated information related to the inventories of each distributor. In some embodiments, the service system 240 may set a predetermined frequency to perform such query. In some embodiments, the service system 240 may allow each distributor to determine the frequency of the query. In some embodiments, the service system 240 may allow each distributor to manually press a button (e.g., an “update” button) to send its inventory information to the service system 240. In some embodiments, whenever a distributor's inventory information changes, the service 240 may cause the distributor 250 to send a notification to the service 240. The notification may include the updated inventory information.

The service 240 may include additional modules 243. The ellipsis represents that there may be any number of additional modules included in the service system 240. Each of the additional modules may provide an additional function to each of the distributors 250, 260, and 270, or each of the suppliers 210, 220, and 230. The service 240 may allow each distributor 250, 260 or 270 to subscribe different services. Each module may be provided with a separate pricing. For example, distributor 250 may decide to subscribe the supplier information module 241 and prediction module 242; and distributor 260 may only want to subscribe the supplier information to save costs.

In some embodiments, the service system 240 may further include a message module that is configured to send notifications and/or generated data to at least some of the distributors 250, 260 and 270. For example, the service system 240 may send the predicted future need to the distributor's computing system and cause the predicted data to be integrated with the distributor's data. Another example, when the service system 240 determines that a purchase order should be placed, a notification may be sent to the buyer who is responsible for purchase orders of the relevant inventory item. The notification may be sent to the distributor's computing system 250 or 260, in which a user interface for the buyer will display the notification. The notification may also be sent to the buyer directly via an email, an SMS, a voice call, etc.

In some embodiments, the service system 240 may further include a user interface for suppliers, such that each supplier can input and/or update its own information into the data system 241. In some embodiments, the service system 240 may further include a communication module configured to query each distributor's data systems 211, 221 periodically. In some embodiments, each of the suppliers may store their information on their server and/or publish the data on a webpage, and the service system 240 only needs to maintain a list of the addresses that links to the supplier's information (e.g., URLs).

In some embodiments, the service system 240 may further causes the distributor's computing system to integrate the predicted future need and/or the recommended purchase order into the distributor's data system, and/or cause the distributor's computing system to generate a visualization to display above-mentioned information and/or integrated data.

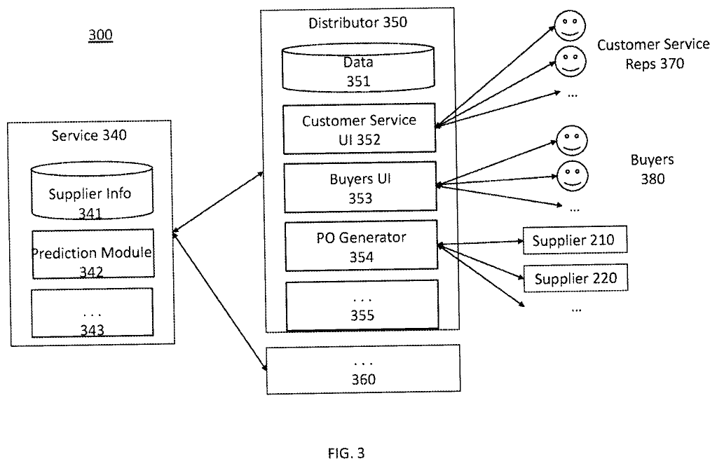

FIG. 3 further illustrates an example embodiment of the optimized supply chain and inventory management system 300. The system 300 includes a service system 340, which is configured to interact with a distributor's computing system 350. The distributor's computing system 350 often includes a local inventory management system. For example, the distributor's computing system 350 may include (but are not limited to) a data system 351, a customer service user interface 352, a buyer's user interface 353, a purchase order generating module 354, etc.

The data system 351 stores all the information related to its inventory and past purchase orders. The customer service user interface 352 often allows customer service representatives 370 to access the inventory data 351 to better provide supports to its customers. The buyer's user interface 353 often allows each of the buyers 380 to review the inventory status of the inventory managed by the respective buyers. The purchase order generator 354 may be integrated into the buyer's user interface to allow the buyers 380 to generate purchase orders. The purchase order generator 354 may also be linked to at least some of the supplier's systems (e.g., the supplier's systems 210 and 220 in FIG. 2), such that when a purchase order is generated, the purchase order is sent to the supplier's system directly. The ellipsis 355 represents that there may be additional modules that may be implemented in the distributor's computing system 350. The ellipsis 360 represents that there may be any number of distributor's computing systems that has access to the service system 340.

The service system 340 may be a similar service system of 240 described in FIG. 2. Based on the information received from the distributor's data system 351 and the relevant supplier's information retrieved from the data system 341, the service system 340 may predict a future need of at least one inventory items. Based on the predicted future need, the service system 340 may generate a recommendation of a purchase order.

In some embodiments, the service system 340 may send the predicted future need to the distributor's computing system 350. The service system 340 may further cause the predicted data to be integrated with the distributor's data 351, and cause the distributor's computing system to generate a visualization to show the predicted future need, and/or to show the integrated data. The service system 340 may further cause the distributor's computing system to generate a notification including information related to the predicted future need. In particular, a notification may be displayed at the user interface presented to a customer service representative 370, and/or a notification may be displayed at a user interface presented to the corresponding buyer 380 who is assigned to manage the inventory item that is related to the predicted future need.

The customer service representatives' user interface 352 may present different visualizations to users. Different settings may be allowed based on the attribute of the users to review different information. For example, customer service representative may be allowed to review the companywide inventory information.

The following discussion now refers to a number of methods and method acts that may be performed. Although the method acts may be disused in a certain order or illustrated in a flow chart as occurring in a particular order, no particular ordering is required unless specifically stated, or required because an act is dependent on another act being completed prior to the act being performed.

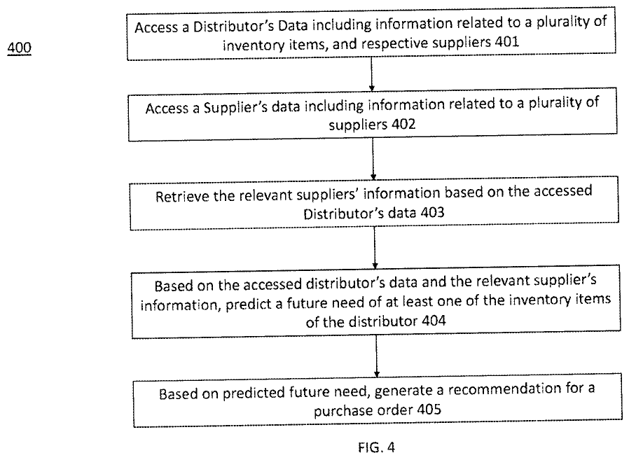

FIG. 4 illustrates a flow chart of an example method 400 for optimizing supply chain and inventory management. The method 400 includes accessing a distributor's data including information related to a plurality of inventory items, and a corresponding supplier for each of the plurality of inventory items (401). For example, as illustrated in FIG. 2, distributor 250's data may be accessed. The distributor 250's data includes information related to inventory A and E. The supplier for supplying inventory A is the supplier 210; and the supplier for supplying inventory E is the supplier 220.

The method 400 further includes maintaining and/or accessing a data system including information related to a plurality of suppliers (402). The information related to the suppliers may include information related to each of the items each of the suppliers supplies, and the minimum order requirement, etc. In some embodiments, the suppliers' information may be manually entered or updated by the service provider. In some embodiments, the suppliers' information may be input by each of the suppliers or automatically imported from the supplier's data system.

Next, based on the distributor's data, each of the corresponding suppliers' information is retrieved from the data system (403). Using the distributor 250 of FIG. 2 as an example again, the distributor 250 has inventories A and E obtained from the suppliers 210 and 220. The data system 241 of the service 240 includes the suppliers 210 and 220's detailed information, such as the minimum order requirements for each of their items, the processing time for each order, etc. Thus, the service 240 can retrieve the minimum requirement of inventory A and E from the data system 241, and the processing time for the relevant order.

Next, based on the distributor's data and the corresponding suppliers' information, future need of at least one of the distributor's inventory items is predicted (404). The prediction may be based on the sales of the inventory in stock, the minimum order requirement of the suppliers, and the processing time for each order, etc. Based on the predicted future need, a recommendation of a purchase order may be generated (405).

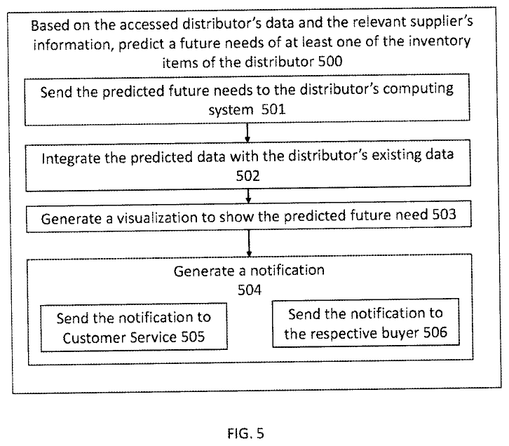

FIG. 5 illustrates a flow chart of an example method 500 for predicting a future need of at least one of the items of the distributor, which may correspond to an embodiment of step 404 of method 400. The method 500 for predicting a future need of at least one of the items of the distributor may include sending the predicted future needs to the distributor's computing system 501. The predicted data may be integrated with the distributor's existing data (502). Based on the predicted future need and/or the integrated data, a visualization may be generated to show the predicted future need and/or the current status of the related items (503). Also, a notification may be generated (504). The notification may be sent to the customer service team (505). Alternatively or in addition, the notification may be sent to the respective buyer who is responsible for the inventory item related to the estimated future need (506). The notification may be integrated into the distributor's existing inventory management system. The notification may also be a separate communication, such as an email, an SMS, and/or a automatic phone call. The notification may be a simple alert symbol, or a detailed chart. A user may decide what type of notifications will be sent, via what communication channel, in what format, and/or in what time frame.

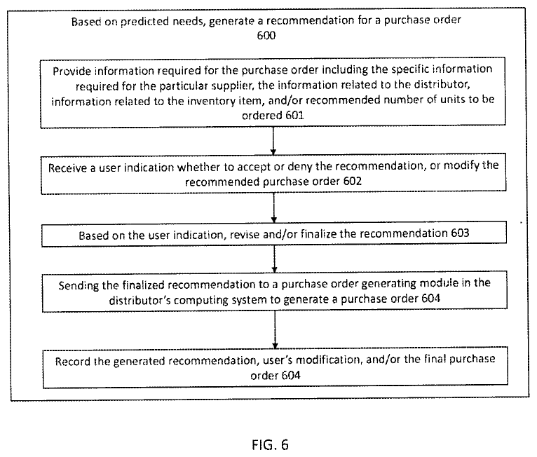

FIG. 6 illustrates a flow chart of an example method 600 for generating a recommendation for a purchase order, which may correspond to an embodiment of step 405 of method 400. The method 600 for generating a recommendation for a purchase order may include providing information required for the purchase order. The information may include (are but not limited to) the specific information required for the particular supplier, the specific information related to the distributor, the specific information related to the inventory item, the specific information related to the buyer, and/or the recommended number of units to be ordered (601).

The method 600 may further include receiving a user indication whether to accept or deny the recommendation, or a user indication indicating a modification of the recommended purchase order (602). Based on the user indication, the recommendation may be revised or finalized (603). For example, if the user accepts the recommendation, the recommendation may be finalized; if the user modifies the recommendation, the recommendation may be modified, then finalized; and if the user rejects the recommendation, the recommendation may be deleted or archived. The finalized recommendation may then be sent to a purchase order generating module in the distributor's computing system to generate a purchase order automatically (604). Alternatively, the purchase order form in the purchase order generating module may be automatically filled in and wait for the buyer to commit to it. Finally, the generated recommendation, the user's modification, and/or the final purchase order may then be recorded as part of the order history of the inventory item (604).

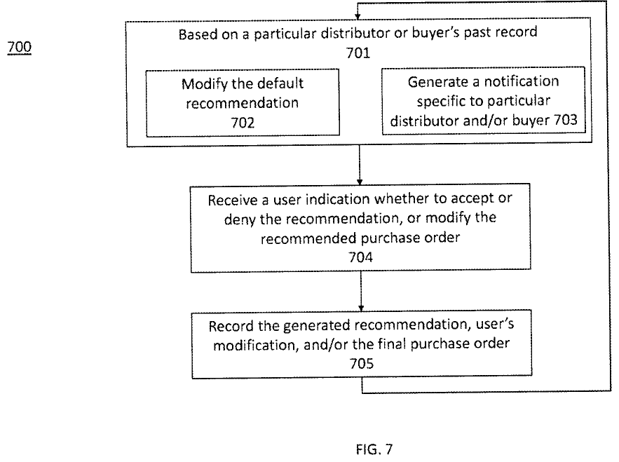

FIG. 7 illustrates a flow chart of an example method 700 for generating a customized recommendation of a purchase order based on a particular distributor or buyer's past records, which may which may also correspond to an embodiment of step 405 of method 400. As described above in FIG. 6, the generated recommendation, the user's modification, and/or the final purchase order may be recorded as part of the order history of the inventory item. When a next recommendation is to be generated, the recommendation may take into account the past order history including the past recommendation, the user's modification and/or the past final purchase order (701). For example, a default recommendation may be generated, and the default recommendation may then be modified based on the order records (702). For example, if the previous recommendation is to order 100 units of item A, and the buyer modified the recommendation to 80 units, the system may automatically adjust the default recommendation by 20% in the next recommendation. Thus, the recommendation is more custom to the particular distributor and/or to the particular buyer. Further, based on the custom recommendation, a custom notification may be generated specific to the particular distributor and/or to the buyer (703). A user indication may then be received to indicate whether to accept or deny the recommended purchase order, or modify the recommended purchase order (705). Thereafter, the generated recommendation, user's modification, and/or the final purchase order may be recorded in the record as a new past purchase order record (705). The record will then become part of the purchase order history, and the next recommended purchase order will be further based on the additional record recorded in the purchase order history.

The more purchase order stored in the record, the more likely the system to be able to generate an accurate recommendation. Different machine learning technologies may be implemented to determine the rules and regularities that a particular distributor or buyer may frequently follow. Based on the determined rules and regularities, a next recommendation may be generated.

For the processes and methods disclosed herein, the operations performed in the processes and methods may be implemented in differing order. Furthermore, the outlined operations are only provided as examples, an some of the operations may be optional, combined into fewer steps and operations, supplemented with further operations, or expanded into additional operations without detracting from the essence of the disclosed embodiments.

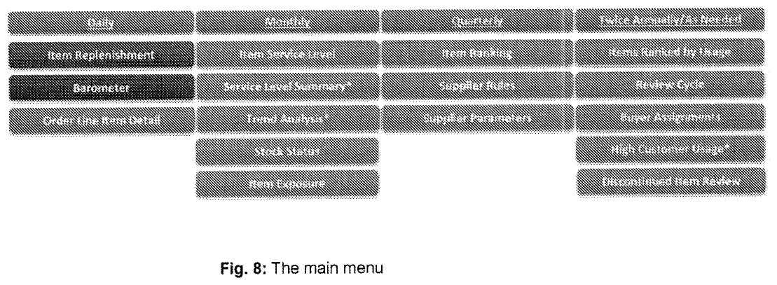

FIGS. 8-20 further illustrate example implementations of the supply chain optimization and inventory management system (herein after referred to as “the system” or “the platform”), though the claims are not limited by these embodiments. The system may include many different modules, for example, a supply barometer module, an inventory replenishment calculator module, a supplier performance report module, an item exposure module, an item ranking module, a null matrix module, an item health tool, etc. Each of these example modules are further described below. Supply Barometer—a tool that continuously monitors inventory activity and notifies purchasing and customer service personnel when a supply line is ready to be purchased (meeting specific supplier requirements and business rules) and when the product is expected to arrive based on a novel approach to lead-time analysis.

Inventory Replenishment Calculator—a tool that aggregates the analysis done on a supply line that makes automated changes and recommended changes for review by purchasing personnel to replenishment parameters. This method analyzes product movement at the transaction level, including forecasts, to assess changes to individual SKUs before purchase orders are placed.

Supplier Performance Report—a tool that monitors SKU performance by supplier and makes recommendations about changes to parameters across entire supply lines. It also flags products that are nearing certain criteria to be returned or moved to other areas of the company to optimize inventory.

Item Exposure module is a tool that monitors SKU performance overall and indicates items that are high risk along a spectrum of low to high exposure risk.

Item Ranking module is a tool that ranks items (in ABC classification) based on a novel combination of hits and cost of sales ranking.

Null Matrix module is a tool that analyzes customer purchases against other customers in their class and offers up items not purchased by the customer that are purchased in their category.

Item Health Tool is a tool that analyzes each item against a number of inputs to determine its overall health. This tool works in concert with the Inventory Replenishment Calculator and the Supplier Performance Report.

The system may be a web-based supply chain management application that currently interfaces with an existing ERP via the middleware application maintained by the existing ERP development teams using RESTful APIs. The system may also include the ability to interface with other ERP systems as well. The platform includes several applications and methods designed to provide solutions that are absent from existing ERP systems. Certain other programs and methods enhance or replace functionality in ERP systems.

FIG. 8 shows the Inventive main menu screen. Menu item ending in asterisk (*) are stand-alone programs within the application that take inputs and generate other reports. Those without the asterisk are reports and utilities that take no inputs or generate reports within the main application.

The Supply Barometer (“SB”) is a critical component of the supply chain management platform. The SB is a real-time monitoring system that continuously evaluates inventory activity across multiple company locations and notifies purchasing agents (via a web portal) that a supply line is ready for review. Once reviewed, the purchase order can be submitted.

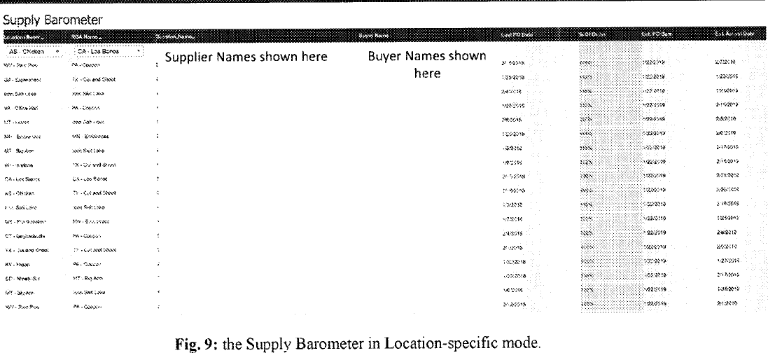

For convenience, the SB may utilize certain threshold parameters set within the existing Enterprise Resource Planning (“ERP”) system. These include, but are not limited to, the minimum order type and amount and minimum freight type and amount which are used to evaluate the % of Order column shown in FIG. 9 below. These parameters, however, can also be set within the platform for ERP systems that do not directly support this functionality.

The SB works in tandem with the Inventory Replenishment Calculator (“IRC”). The details about IRC are further described below.

The Supplier Rules (“SR”) and Supplier Parameters (“SP”) are table resources in the system's database(s) that store specific rules and parameters by company, location, and supplier ID. Most programs and reports within the platform access these resources pre-runtime.

For example, the Supplier Rules table contains rules for which company+location+supplier combinations should be included in the Supply Barometer, in ranking, in review cycle, and in the Supplier Parameters. This allows a client administrator to effectively discontinue a supplier, for example, where that functionality currently cannot be implemented easily.

Table 1 shows a small sample of the type of data that may be contained in the table described above.

TABLE 1
Sample output of the is_supplier_rules table

| Rules_uid | Company_id | Location_id | Supplier_id | Barometer | Ranking | Review_cycle | parameters |
|---|---|---|---|---|---|---|---|
| 1 | XXXX | 111 | 12345 | Y | Y | Y | N |
| 2 | XXXX | 222 | 23456 | N | Y | Y | N |

Another example, the Supplier Parameters table contains rules for company+location+supplier combinations for purchases classes. These classes serve to segment inventory. Where many ERP systems force a single series of purchases classes that are then applied to each supplier, The platform allows the client to define as few or as many purchase classes as are necessary for each company+location+supplier combination they deem necessary. The Item Ranking tool discussed below handles the logic of purchase class assignment to individual items within a supply line for a particular company+location combination.

Each purchase class can then accept a set of default supplier parameters or they can be changed according to specific needs. These parameters include the periods to supply, target service level, periods to include in forecasting calculations, whether or not to include or exclude zero usage periods, and the lower and upper bounds of automated updates for items within that class.

These tables may be part of the system's installation and be pre-populated by a procedure that pulls the information from the ERP. If this information is not available, it can be entered manually via the system's application.

As explained previously, the SB is configured to analyze and aggregate required item information stored in the existing ERP. Based on the analysis, the SB may then calculate the various buy requirements for each location and supplier combination. The SB may also implement a statistical elimination to exclude purchase orders with abnormal lead times from standard lead time calculations. This is important in accurately forecasting the estimated arrival date (Est. Arrival Date in FIG. 9 above) of a purchase order once placed. The SB may also find the last actual purchase order date by location and supplier which is returned as the Last PO Date in FIG. 9 above. The SB may also aggregate the parameters mentioned in the description that are stored in the suppler. After all the information has been collected, the SB takes those results and performs the calculations necessary to produce the % Of Order column in FIG. 9 above.

The Inventory Replenishment Calculator (“IRC”) may perform a number of functions. At any time, a client user can access the IRC via the Supply Barometer by simply selecting a supplier. The review may be done by each location. The system may also allow reviewing recommended changes for all locations simultaneously.

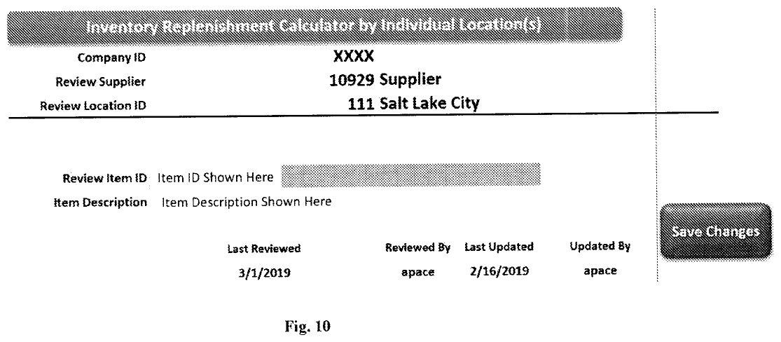

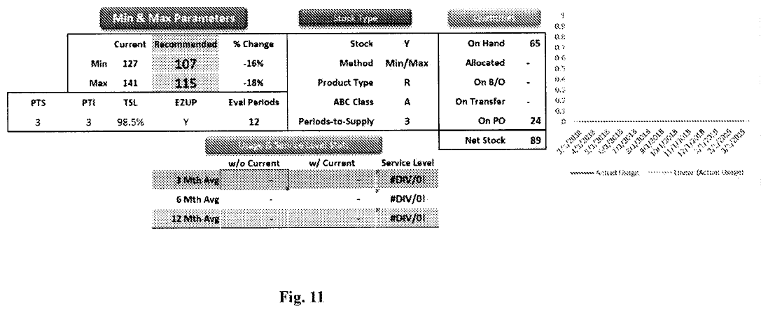

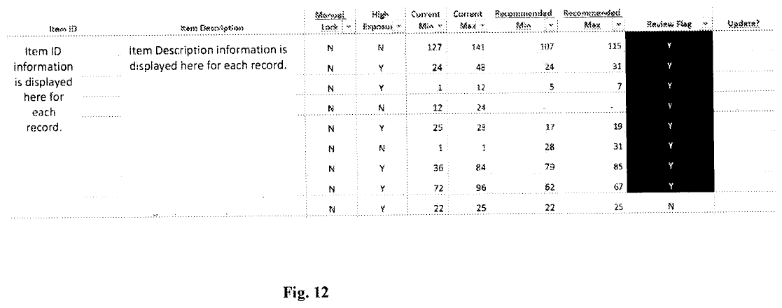

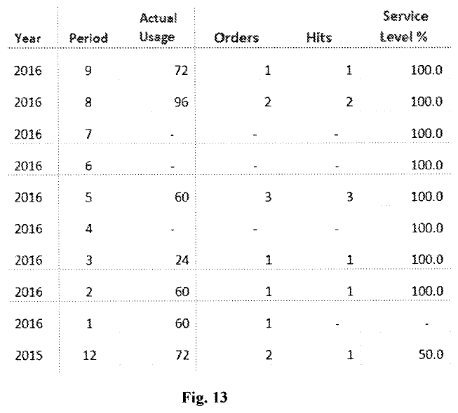

When the user has accessed the IRC, they are presented with a wealth of information. This information is show in FIGS. 10-13. FIGS. 10-13 illustrates various portions of the IRC. FIG. 10 is a visualization that reminds the user which item is being reviewed. FIG. 11 is a visualization that contains pertinent summary information for the items including the new recommended replenishment parameters that will be passed back to the ERP. FIG. 12 is a visualization that shows some details for each item in the supply line. FIG. 13 illustrates a visualization that shows a usage summary for the review item in question.

The IRC checks for the existence of the table including replenishment parameters in the database. This table houses all the data necessary to run the IRC. This data is aggregated from resources inside the system and a number of tables in the existing ERP.

This table may be accessed by all users of the application simultaneously thus it has a field to track data by user. Average lead time may be calculated and updated to the table including replenishment parameters by item. The existing ERP may store certain data by period and year only. The IRC may allow a user-defined function to quickly convert traditional dates into a YYYYMM format based on any number of periods into the past or future. The IRC may also determine average daily usage based on the information stored in the existing ERP to establish a baseline for error modeling. The IRC may also analyze information stored in the existing ERP to determine the number of units sold for comparison against the established baseline. The IRC may further define a threshold as a customer-specific risk threshold. The risk can be calculated based on the type of customer in question, the spread of products they buy, and the length of time the customer has been in business. The IRC may also analyze each item in the dataset based on a user parameter that sets how many periods to include. Average usage information including and/or excluding the current period as well as including and/or excluding periods with zero usage may be analyzed. The IRC may use various statistical methods to calculate the recommended dynamic minimum and/or dynamic maximum that will be passed back to an existing ERP application. The IRC may also review the results of the previous results to determine which items require a user's attention and which items can be updated automatically. These automatic updates are based on thresholds initially established by the user. The IRC may also make periodic recommendations to changes to these automated thresholds.

The Supplier Performance Report (“SPR”) may be implemented as an important companion to the Inventory Replenishment Calculator (“IRC”) and Supply Barometer (“SB”). The SPR is a set of tools that allow the user to quickly evaluate several metrics related to each supplier by location. These metrics include the following and are presented in annual, quarter, and period summary format with comparisons to the same timeframe the previous year. Comparison data can be extended to multiple time periods in the past. The SPR may generate reports including (but are not limited to) the following information: (1) Total Purchases, Sales, Cost of Sales, and Gross Margin ($ and %), (2) Average Inventory Value, (3) Inventory Turns, (4) Turn and Earn Index (TE), (5) Gross Margin Return on Investment (GMROI), (6) Lead Time and Lead Time Issues, (7) Supplier Fill Rate.

Goals can be set and measured against the metrics indicated above. The SPR also allows the user to track several programs related to the supplier such a rebate and growth programs. Each supplier and location can have specific goals and programs.

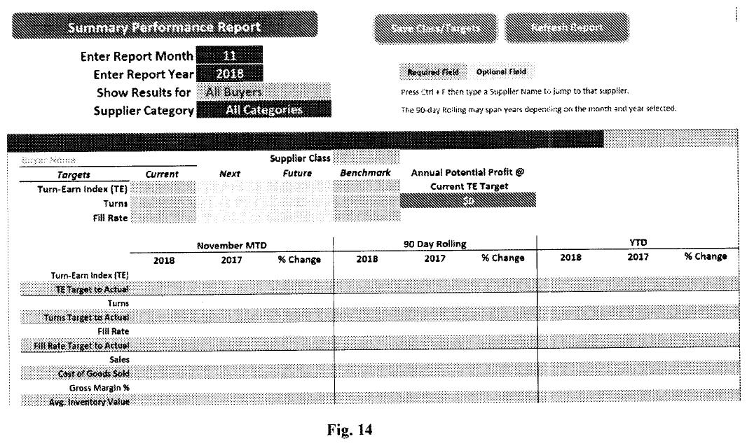

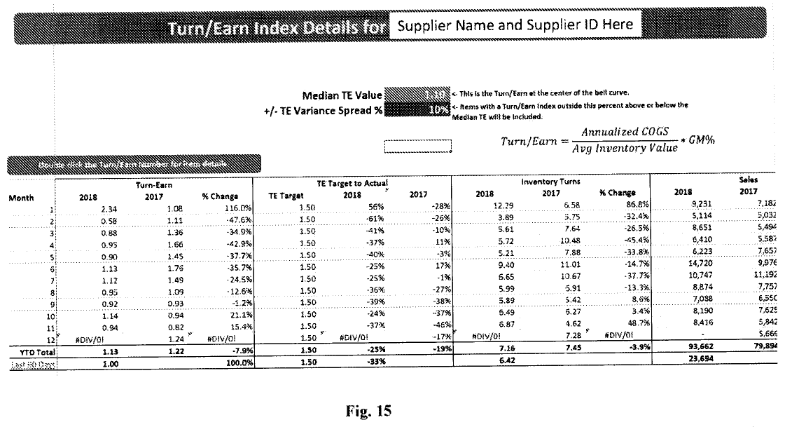

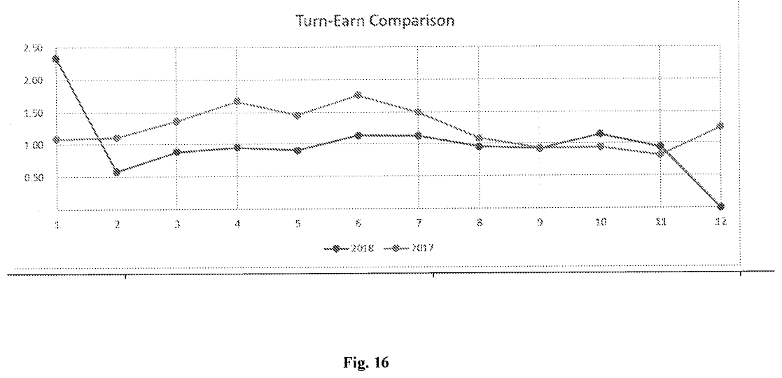

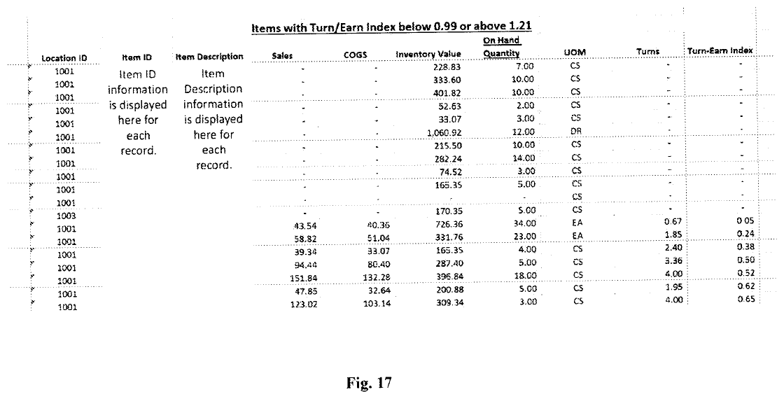

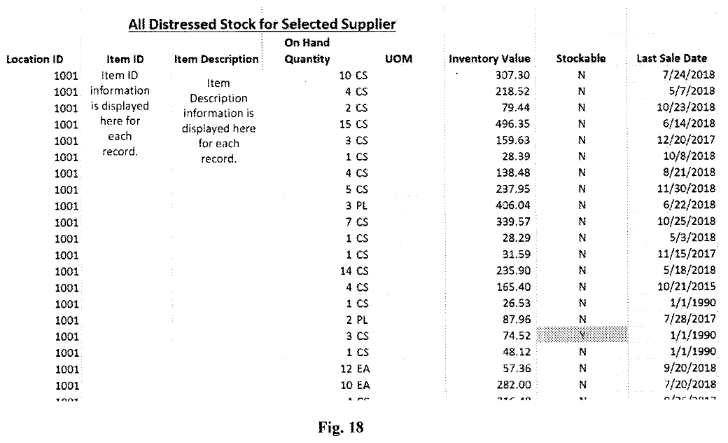

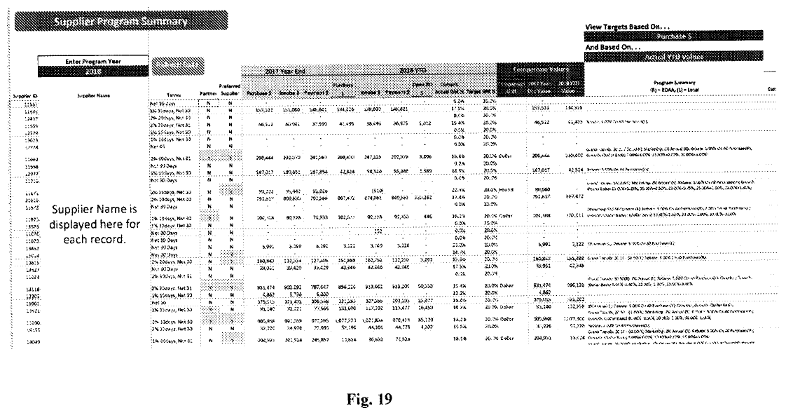

When the user has accessed the SPR, they are presented with a wealth of information. This information is show in FIGS. 14-20. FIG. 14 illustrates a main screen for the SPR including fields for rules. This template shows metrics for 3 different time periods. FIG. 15 illustrates a visualization that shows several details from the supplier performance details. This section shows the Turn/Earn Index for a particular supplier. FIG. 16 illustrates a visualization that shows comparison graphs showing changes in the Turn-Earn over time. This graph can be displayed for any of the metrics mentioned on the first page of this attachment. FIG. 17 illustrates a visualization that shows items that fall outside the desired range. The desired range can be defined by the user or automatically generated by the system. This type of analysis can be done for each metric mentioned in the specification. FIG. 18 illustrates a visualization that shows a list automatically generated by the system displaying items that have various issues. FIG. 19 illustrates a visualization that show a summary list of all supplier programs and current performance based on those programs.

The SPR may include functions that are called on demand to generate the reports shown in the FIGS. 7-13. The functions can act independently. Alternatively, some of the functions may interact with each other. The SPR checks for the existing information contained in the system or the existing ERP. If necessary, the SPR may updated the information in the system or the existing ERP. The SPR may aggregate information, and generate a table that houses all the data necessary to run the IRC. This data is aggregated from resources inside the system or platform and/or the existing ERP system. This table may be accessed by all users of the application simultaneously thus it has a field to track data by user. The SPR may include many different procedures that creates the summary content that gets stored in the table. The SPR may take different inputs, such as Period, Year, Starting Buyer, Ending Buyer, Starting Supplier Category, and Ending Supplier Category. These results are returned to the screen shown in FIG. 8. The SPR may summarize the data stored in the ERP and display the results in the screen show in FIG. 7. The SPR may also pull detailed information by metric from the ERP and summarizes them based on the screen shown in FIGS. 9 and 10. The SPR may also return outlier items based on the selected metric and the boundaries specified as shown in FIG. 9. The results are returned as shown in FIG. 11. The SPR may also aggregate information by location and item for items that are distressed. Distressed items are those that are non-stock with quantity on hand (regardless of value) and stock items with low movement relative to the quantity on hand and other metrics. The SPR may also aggregate information generated and stored in the system.

The Item Exposure Report (“IER”) calculates the level of exposure experienced by each item at a specified location within the user company. The report takes multiple user inputs, for example: (1) Warehouse Location—The physical location of the product being analyzed; (2) Top x Customers per Item to Include—The top number of customers to be considered when evaluating the exposure level. The higher this number, the higher the likelihood an item will be returned as over-exposed; (3) Exclusion Threshold %—The percent at which, if exceeded by the top x customers per item to include, an item is considered over-exposed; (4) Include Direct Ship Orders (Y/N)—should direct ship orders be included; (5) Include Items with Sales After—this is a limiting date that will exclude any items with sales prior to the date specified. It also excludes any customers who have not purchased anything since this date; (6) Only Include Items Added Before—this is a limiting date that excludes items from reporting that were added to the system on or after the date.

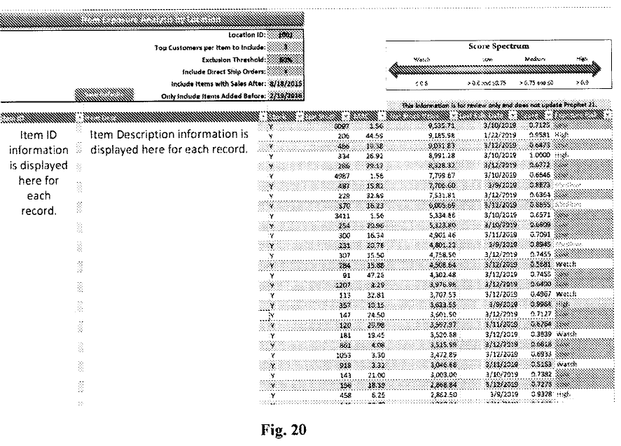

FIG. 20 illustrates a visualization that shows a sample of inputs and the resultant output of the IER. The far-right column indicates the amount of exposure based on the parameters.

The IER pulls a list of all the customers who have had invoiced sales since the date specified in the parameters. The list of items may include in the review process based on the parameters. Invoice information may be obtained from the ERP system. The IER performs final analysis and returns the results to the user interface.

The Item Ranking Tool (“IRT”) performs ABC classification based on a novel combination of the cumulative ranking of cost of sales and hits for each item by location and primary supplier. The ranking tool serves to group items into performance buckets which govern parameters such as periods to supply, safety stock, and service level percent. This tool may have no user interface of its own but returns information to the Inventory Replenishment Calculator (“IRC”) described in Attachment C. The interface is under development.

The IRT performs the analysis based on the supplier selected in the IRC and returns results to each item. The IRT may require three parameters: (1) Supplier ID—This is the internal supplier identifier used throughout the P21™ application; (2) Analysis Periods—How many periods should be included in the analysis. The default may be 12; (3) Include Current Period—Should the current period be included in the analysis. Future versions will rank the item using a statistical model that will include the current period in analysis but will automatically select whether or not to rank an item based on the current period based on error.

The IRT collects all items for the location and supplier being analyzed in the IRC. The IRT may further aggregate the total hits and hits rank for each item between the starting and ending periods as calculated using the analysis periods and include current period flag. The IRT may also aggregate the total cost of sales, total gross margin, total units sold, the average gross margin, and the cost of sales rank for each item between the starting and ending periods as calculated using the analysis periods and include current period flag. The IRT may analyze the aggregated information and prepare them for return to the user interface. The essential analysis performed here may be a simple weighted average comparison between the hits rank and cost of sales rank from procUsage and procSales, respectively. The analysis may also include certain thresholds for ABCD class segregation are set previously and stored in a table that is dedicated to store supplier ranking information. The hits rank and cost of sales rank values may be averaged then the cumulative to total percentage calculated. The ABCD class may be then assigned based on the threshold percentage of each class. For example, if A class represents 20% of the cumulative hits+cost of sales rank average then any items between 0% and 20% will be included as A items, etc. The IRT may finally return the results to the user interface.

The Null Matrix Report (“NMR”) generates a list of items that are sold within a particular customer group that are not purchased by the analysis customer selected in the parameters. It is sorted in order of the popularity of each item in descending order.

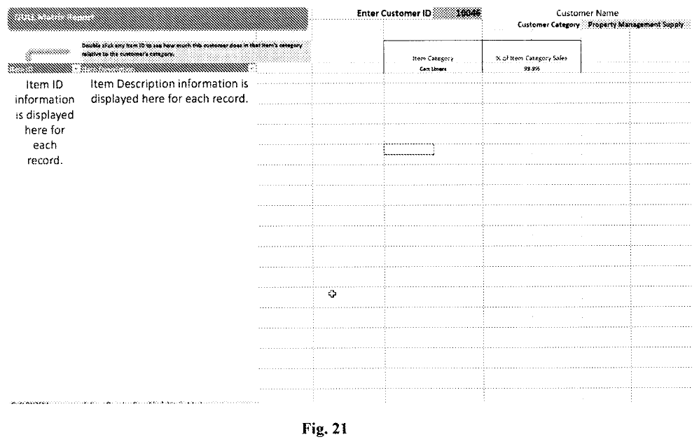

The secondary output of this report is another report that indicates what the total sales to a customer have been in the category of the item selected in the output. FIG. 21 illustrates a sample screenshot of the null matrix. These are items—sorted by popularity—that are sold to the Property Management Supply customer category that are not purchased by Lone Peak Supply (a fictional company name)

The NMR may simply get the customer category from a customer information table stored in the ERP. The ERP may have the ability to restrict items sales to a particular customer or group of customers. These items are excluded from the results so an excluded item is not offered to a customer who can't purchase it. The NMR may also aggregate a list of the items purchased by the customer or customer category in the last 365 days. This limit can be user-defined. The NMR may also extract the items from the aggregated list and sort them according to popularity, and return the results to the user.

The Item Health Tool (“IHT”) performs an inventory analysis on all items based on different input parameters, for example

Location—the stocking location being analyzed

Minimum Gross Margin Percentage—The minimum gross margin that should be made, on average, in order for an item to be considered a healthy stock item.

Minimum Turns—The minimum inventory turnover required for an item to be considered a healthy stock item.

Minimum Gross Margin Return On Investment (GMROI)—The minimum GMROI required for an item to be considered a healthy stock item.

Start Date—The date that specifies how far back the analysis should look at history.

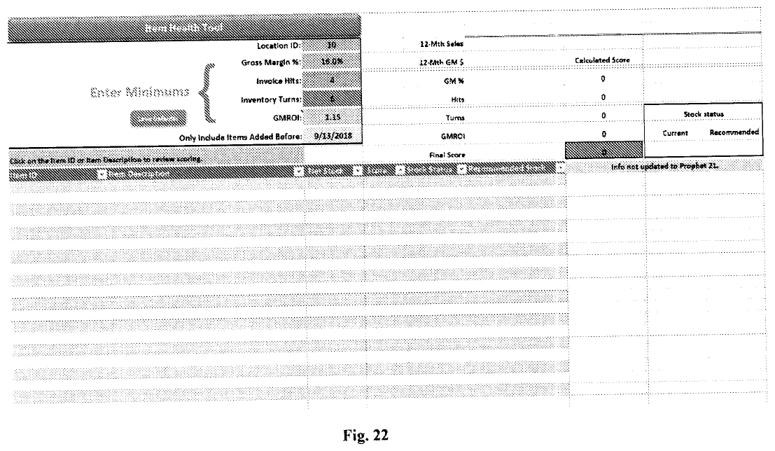

Defaults can be set globally. These defaults are regularly evaluated against the current information to make sure they are in line with reality. All items for a location are displayed along with recommended changes to the stock status (stock to non-stock and non-stock to stock) along with scoring information. Stock items that score low are recommended for non-stock status and vice versa. FIG. 22 illustrates a sample screenshot of the IHT with sample parameters

The IHT utilizes data in the ERP table that includes information related to average inventory value along with the information related to demand period and inventory. The IHT may then aggregate sales information based on the parameters specified above. The IHT may then analyze each item against the data in the ERP system and the parameters indicated above. The item's score is determined, and results are returned.

Users may also define various functions. The following is a list of novel user-defined functions (UDFs) that may be utilized in various parts of the platform. For example a UDF may be directed to a prior period. The UDF may take a single user input as a period off set. If the period off set is less than 0, the UDF returns a computed YYYMM value before the current date. For period off set more than 0, the UDF returns a computed YYYYMM value after the current date. For period off set equal to 0, the UDF returns the computed YYYYMM value for the current date.

Another UDF may be directed to working days. This UDF may take two user inputs: (1) the company ID and (2) the comparison date. o Based on the comparison date, the UDF calculates the number of work days that have transpired in the current year based on workdays defined in the ERP.

Another UDF may be directed to average daily usage. This UDF may make use of UDF prior period and UDF working days to calculate a more exact average daily usage. It takes as its input the company ID, location ID, and inventory ID values for a specific item in the database. Based on the inputs and the other UDFs, this UDF calculates an exact average daily usage for an item and compares previous usage to current usage.

Another UDF may be directed to find net stock. This UDF may take as inputs the company ID, location ID, and inventory ID for a specific item. The system calculates returns the net stock based on a standardized net stock calculation. For example, the following equation may be used to calculate the net stock.

Net Stock=On Hand−Allocated−Backordered+On PO+In Process−Protected+In Transit−Reserved

Another UDF may be directed to parse number into a string. This UDF may take a single input—a string of up to 8,000 ASCII characters—and extracts only numbers from the string.

As described above, the system or platform is a collection of computerized techniques, methods, procedures, formulae, functions, inventions, and discoveries that performs, but is not limited to, inventory management and custom marketing, which includes an ecommerce component. A more specific, but not exhaustive, list of the various functions, spreadsheets, stored procedure and other software elements used to carry out the functions of the Software and its modules is attached hereto and included in this description by reference.

The inventory management portion of the system is a combination of statistical methods and models used to accurately forecast inventory purchases and a proprietary portal that helps inventory management, customer service, and executive personnel know when a particular supply line is ready for purchase. It also includes many custom reports for analyzing and responding to inventory conditions in real-time.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, when executed by the one or more processors, cause the computing system to:
access a distributor's computing system to access distributor's data including information related to a plurality of inventory items and a corresponding supplier for each of the plurality of inventory items;
access a data system including information related to a plurality of suppliers;
based on the distributor's data, retrieve each of the corresponding suppliers' information from the data system;
based on the distributor's data and the corresponding suppliers' information, predict future need of at least one of the plurality of inventory items.

2. The computing system of claim 1, wherein the predicting a future need of at least one of the plurality of inventory items comprises:
sending the predicted future need to the distributor's computing system;
causing the predicted data to be integrated with the distributor's data;
causing the distributor's computing system to generate a visualization to show the predicted future need; and
causing the distributor's computing system to generate a notification including information related to the predicted future need.

3. The computing system of claim 2, wherein the notification is displayed at a user interface presented to a customer service team of the distributor.

4. The computing system of claim 2, wherein the notification is displayed at a user interface presented to a corresponding buyer who is assigned to manage an inventory item that is related to the predicted future need.

5. The computing system of claim 1, based on the predicted future need, the computing system is further caused to generate a recommendation of a purchase order.

6. The computing system of claim 5, wherein the generating a recommendation of a purchase order comprises:
providing information required for the purchase order, the information including specific information required for the corresponding supplier, specific information related to the distributor, specific information related to the inventory item, and/or recommended number units to be ordered.

7. The computing system of claim 6, the generating a recommendation of a purchase order further comprises:
receiving a user indication whether to accept or deny the recommendation, or an indication to modify the recommendation; and
based on the user indication, revise or finalizing the recommendation.

8. The computing system of claim 7, wherein the generating a recommendation of a purchase order further comprises:
sending the revised or finalized recommendation to a purchase order generating module in the distributor's computing system to cause a purchase order to be generated on the distributor's computing system.

9. The computing system of claim 8, wherein the generating a recommendation of a purchase order further comprises:
recording the generated recommendation, user's modification, and/or the final purchase order.

10. The computing system of claim 8, wherein the generating a recommendation of a purchase order further comprises:
accessing records related to previous recommendations, user modifications, and/or the final purchase orders of the distributor and/or the corresponding buyer; and
based on the accessed records, generating a customized recommendation tailored to the distributor and/or the corresponding buyer.

11. The computing system of claim 1, wherein the computing system further provides a user interface for at least some of the plurality of the suppliers, such the suppliers' data system is configured to receive input data from each of the at least some of the plurality of the suppliers.

12. A method implemented in a computing system for optimizing supply chain and inventory management, the method comprising:
accessing a distributor's computing system to obtain distributor's data including information related to a plurality of the distributor's inventory items and a corresponding supplier for each of the plurality of inventory items;
accessing a data system including information related to a plurality of suppliers;
based on the distributor's data, retrieving each of the corresponding suppliers' information from the data system;
based on the accessed distributor's data and the corresponding suppliers' information, predicting a future need of at least one of the plurality of inventory items.

13. The method of claim 12, wherein the predicting a future need of at least one of the plurality of inventory items comprises:
sending the predicted future needs to the distributor's computing system;
integrating the predicted data with the distributor's data;
generating a visualization to show the predicted future need; and
generating a notification including information related to the predicted future need to the distributor's computing system.

14. The method of claim 13, wherein the notification is displayed at a user interface presented to a customer service team of the distributor.

15. The method of claim 13, wherein the notification is displayed at a user interface presented to a corresponding buyer who is assigned to manage the corresponding inventory.

16. The method of claim 12, further comprising based on the predicted future need, generating a recommendation of a purchase order.

17. The method of claim 16, wherein the generating a recommendation of a purchase order comprises:
providing information required for the purchase order, the information including specific information required for the corresponding supplier, specific information related to the distributor, specific information related to the inventory item, and/or recommended number units to be ordered.

18. The method of claim 17, the generating a recommendation of a purchase order further comprises:
receiving a user indication whether to accept or deny the recommendation, or an indication to modify the recommendation; and
based on the user indication, revise or finalizing the recommendation.

19. The method of claim 17, wherein the generating a recommendation of a purchase order further comprises:
sending the revised or finalized recommendation to a purchase order generating module in the distributor's computing system to cause a purchase order to be generated on the distributor's computing system.

20. A computer implemented process for optimizing supply chain and inventory management, the process comprising:
accessing a distributor's computing system to access distributor's data including information related to a plurality of inventory items and a corresponding supplier for each of the plurality of inventory items;
accessing a data system including information related to a plurality of suppliers;
based on the distributor's data, retrieving each of the corresponding suppliers' information from the data system;
based on the accessed distributor's data and the corresponding suppliers' information, predicting a future need of at least one of the plurality of inventory items; and
based on the predicted future need, generating a recommendation of a purchase order.
